(19) United States
(12) Patent Application Publication
(10) Pub. No.: US 2010/0282187 A1
(43) Pub. Date: Nov. 11, 2010

(54) ENGINE WITH TOP-MOUNTED TOOL

(75) Inventor: Richard J. Gilpatrick, Whitewater, WI (US)

Correspondence Address: Foley & Lardner LLP, 777 East Wisconsin Avenue, Milwaukee, WI, 53202-5306, US

(73) Assignee: Briggs & Stratton Corporation

(21) Appl. No.: 12/436,638

(22) Filed: May 6, 2009

(51) Int. Cl. F02B 63/00; B08B 3/02; F04B 17/05; F01M 11/00; F02N 3/02; F02M 37/00

(52) U.S. Cl. 123/2; 239/722; 417/364; 123/196 R; 123/185.3; 123/434

(57) ABSTRACT

A pressure washer system includes a mounting platform, a water pump, and a motor mounted to the mounting platform. The water pump has a housing with an inlet and an outlet. The motor is attached to the water pump such that the motor is designed to drive the water pump. The motor is mounted vertically below the water pump.

### BACKGROUND

The present invention relates generally to the field of power equipment systems having tools driven by engines. More specifically the invention relates to power equipment including a vertical shaft internal combustion engine designed to drive a tool, such as a pump, mounted to the top of the engine.

Vertical shaft combustion engines, originally designed for walk-behind motorized lawn mowers, have been adapted for use with other power equipment. For example, an engine suitable for a lawn mower may instead power an electric generator or an axial cam pump in a pressure washer. An extension of the crankshaft, also known as a power take-off (PTO) shaft, extending from the base of the engine transfers torque to belts, pulleys, gears, other shafts, etc. to drive one or more tools. The PTO shaft can also directly power one or more tools, such as blades, pumps, rotors, and fans.

Some four-stroke vertical shaft internal combustion engines include components, such as oil and fuel systems, that rely upon gravity and engine orientation. For example, when an engine is right-side-up, engine fuel lines may collect gas from the bottom of a gas tank, and sumps and slingers may pump or fling oil from a pool in the bottom of a crankcase. If upside-down, the engine may be able to run briefly, but due to the inverted engine orientation, the engine may leak oil internally or externally, may produce air bubbles in the fuel line, may overheat and excessively wear due to an inability to properly lubricate, and may have reduced functionality in other ways.

### SUMMARY

One embodiment of the invention relates to a pressure washer system. The pressure washer system includes a mounting platform, a water pump, and a motor mounted to the mounting platform. The water pump has a housing with an inlet and an outlet. The motor is attached to the water pump such that the motor is designed to drive the water pump. The motor is mounted vertically below the water pump.

Another embodiment of the invention relates to a powered tool system. The powered tool system includes a support frame, a powered tool, and an internal combustion engine. The engine is mounted to the support frame and coupled to the powered tool such that the engine is designed to drive the powered tool. The powered tool is mounted substantially above the engine. The engine has an upwardly-directed power take-off extension for engaging the powered tool.

Yet another embodiment of the invention relates to a combustion engine. More specifically, the combustion engine includes a crankshaft and a power take-off extension attached to the crankshaft. The engine further includes a crankcase enclosing the crankshaft, where the power take-off extension extends through an opening in the crankcase. The engine further includes a lubrication system for distributing lubricant within the crankcase. The lubrication system relies upon the engine generally being in a first orientation, where the engine in the first orientation has a top and a bottom, with the top vertically above the bottom. The power take-off extension extends vertically upward through the top of the engine.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a pressure washer system according to an exemplary embodiment.

FIG. 2 is a side view of a pump mounted on top of an engine according to an exemplary embodiment.

FIG. 3 is a perspective view a power take-off extension and mounting plate on top of an engine according to an exemplary embodiment.

FIG. 4 is a perspective view an axial cam pump configured to attach to the mounting plate and power take-off extension of FIG. 3.

FIG. 5 is a schematic cut-away side view of an engine according to an exemplary embodiment.

FIG. 6 is a perspective view of a pump mounted on top of an engine according to another exemplary embodiment.

FIG. 7 is a perspective view of the pump mounted on top of the engine of FIG. 6 having a pump shroud according to an exemplary embodiment.

FIG. 8 is a perspective view of a pump mounted on top of an engine according to yet another exemplary embodiment.

FIG. 9 is a perspective view of a pressure washer system according to another exemplary embodiment.

### DETAILED DESCRIPTION OF THE EXEMPLARY EMBODIMENTS

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

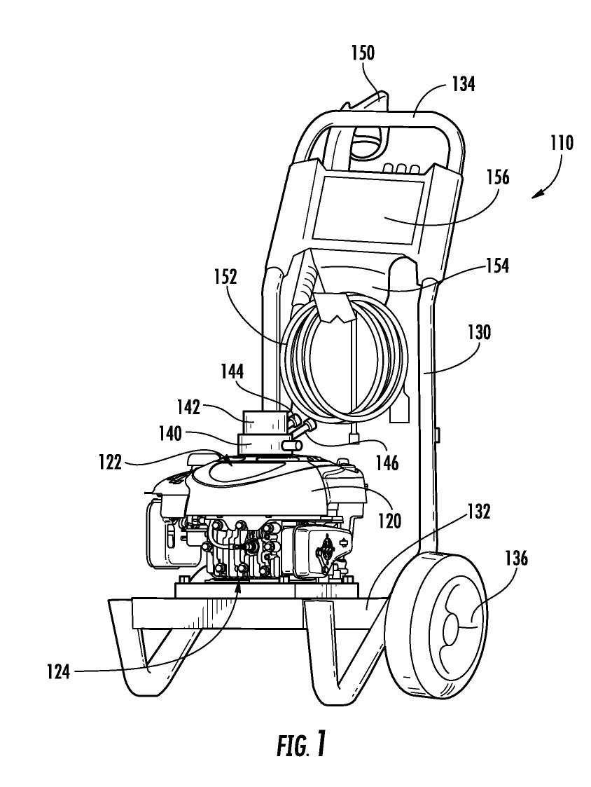

FIG. 1 shows a perspective view of a powered tool system according to an exemplary embodiment. The powered tool system is in the form of a pressure washer system 110 including a motor, a support structure, and a water pump. The motor is shown as a vertical shaft engine 120 having a four-stroke internal combustion cycle. The engine 120 is designed to be operated primarily in a right-side-up orientation, as shown, with a top 122 and a bottom 124. The water pump is shown as an axial cam pump 140 having a housing 142 with an inlet 144 and an outlet 146.

The support structure is shown as a frame 130 (e.g., dolly) with a handle 134 and a base plate 132, where the base plate 132 serves as a mounting platform for mounting the engine 120 to the frame 130. The engine 120 is mounted vertically below the inlet 144 and the outlet 146 of the axial cam pump 140. More specifically, FIG. 1 shows the axial cam pump 140 mounted to the top 122 of the engine 120, where an upwardly-directed shaft of the engine 120 engages an rotary member within the housing 142 to drive a flow of water through the axial cam pump 140. The frame 130 is configured to be rocked backward about wheels 136 on the frame 130 and rolled by a user.

Also shown in FIG. 1, the pressure washer system 110 includes a spray gun 150 and a hose 152. In some embodiments, the spray gun 150 can be coupled to a chemical, such as soap in a container, and the spray gun 150 adds the chemical to the flow of water passing through the spray gun 150. In other embodiments, the spray gun 150 may include a turbulence control assembly, such as screens and arrays of conduits placed along the flow of water, for producing a water stream output with a reduced turbulence, or a laminar flow. The hose 152 is wrapped around a rack 154 for storage. The rack 154 may also store an electric cord for embodiments employing an electric motor. Additionally, in some embodiments, the support structure also includes a controller 156, which may be wired to or in radio frequency communication with the engine 120 and the axial cam pump 140. The controller 156 allows a user to adjust performance and flow characteristics related to the engine 120 and the axial cam pump 140, such as engine speed, water pressure, flow rate, engine ignition, engine idling, and other characteristics.

While the embodiment shown in FIG. 1 employs the engine 120 having a four-stroke cycle, some embodiments employ other motors, such a two-stroke engine or an electric motor. Still other embodiments employ engines having a supplemental shaft (e.g., cam shaft or flywheel) coupled to the crankshaft, the supplemental shaft configured to engage a tool coupled to the top of the engine. The supplemental shaft may be geared to the crankshaft, belted to the crankshaft, or otherwise rotatably coupled to the crankshaft, and thus indirectly coupling the crankshaft to a powered tool.

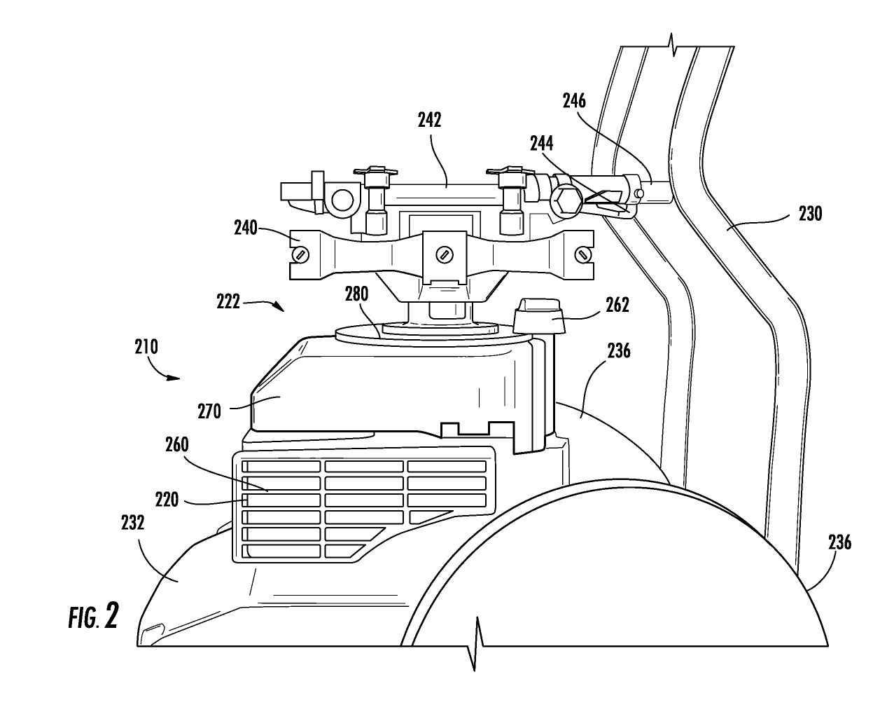

FIG. 2 shows a side perspective view of a pressure washer system 210 according to another exemplary embodiment. The pressure washer system 210 includes a duplex water pump 240 (positive displacement pump with two pistons) having a housing 242, an inlet 244, and an outlet 246. Other embodiments include triplex pumps, and other positive displacement pumps. The pressure washer system 210 also includes a combustion engine 220 having an exhaust muffler shell 260, an oil fill cap 262 above a funnel leading to a crankcase, and other components characteristic of combustion engines. In addition, the pressure washer system 210 includes a support frame 230 having at least two wheels 236 and a base plate 232, such that the pressure washer system 210 can be rolled to a desired location for operation. The pump 240 is mounted on a top 222 of the combustion engine 220 via a blower housing 270 having a mounting surface joined to a mounting plate 280 on the pump 240.

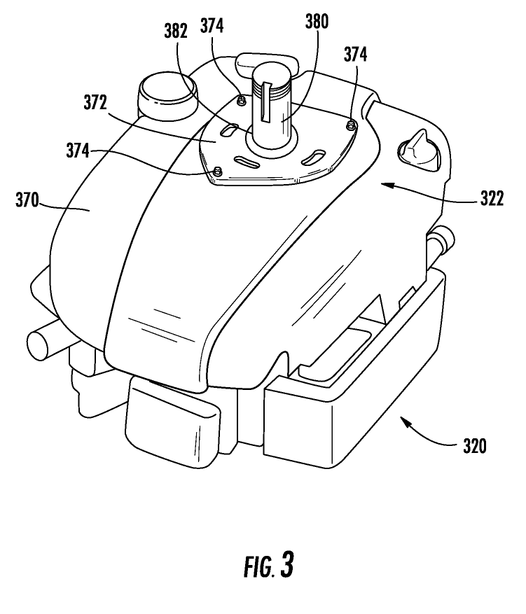

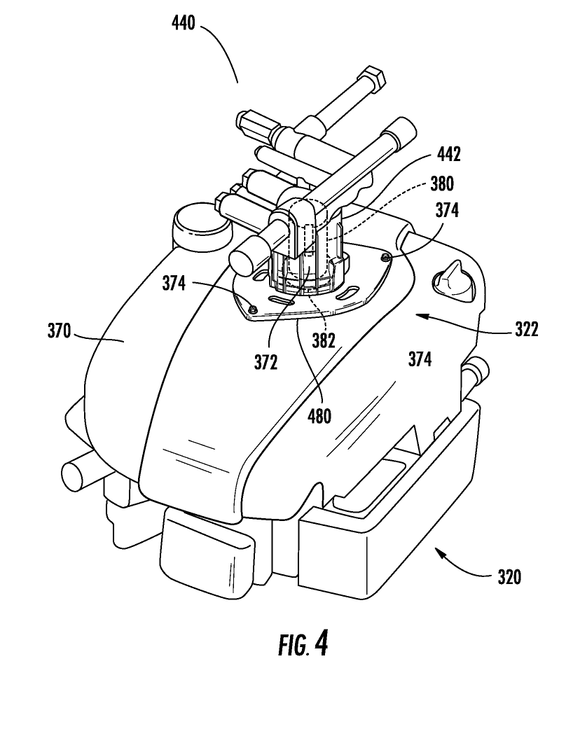

FIGS. 3-4 show perspective views of an engine 320 and a pump 440, respectively, according to another exemplary embodiment. The engine 320 includes a blower housing 370 covering a top 322 of the engine 320, where the engine 320 is configured to be fastened to the pump 440 via the blower housing 370. As shown in FIG. 3, the blower housing 370 includes the mounting surface 372 with an aperture 382 for a power take-off extension 380 of the engine crankshaft to extend through the aperture 382. The power take-off extension 380 may be integral with the crankshaft, coupled to the crankshaft directly, or indirectly coupled to the crankshaft. Also the power take-off extension 380 may be rigidly or flexibly coupled to the crankshaft, such that torque of the crankshaft is transferred to the power take-off extension 380. Additionally, the mounting surface 372 includes a plurality of fastener holes 374. Bolts, screws, pins, and other fasteners may be used with the fastening holes 374 to attach a tool to the mounting surface 372. In other embodiments, the mounting surface 372 lacks fastening holes 374, but instead is configured to support other fastener types for attaching a tool to the mounting surface 372, such fastener types including glues, welds, sliding bars, latches, clips, and other fasteners. In some embodiments, the housing is a top of a crankcase and not an additional piece.

In FIG. 4, the pump 440 is configured to mount directly to the top 322 of the engine 320 by way of a mounting plate 480 coupled to a housing 442 of the pump 440. The mounting plate 480 may be attached to the mounting surface 372 of the engine 320 with bolts, screws, pins, etc., extending through the fastening holes 374. With the pump 440 mounted to the top 322 of the engine 320, a user need not reach beneath the engine 320 to access the pump 440. Further, the weight of the engine 320 is below the pump 440, providing increased vertical stability and reducing the chance of accidental tipping. In some embodiments, the mounting surface 372, the blower housing 370, and the mounting plate 480 are robustly designed to withstand shear forces in reaction to torque applied from the power take-off extension 380 to the pump 440. In variant embodiments, the mounting plate 480 is shaped like a shield, a flat donut, a square, or other shapes.

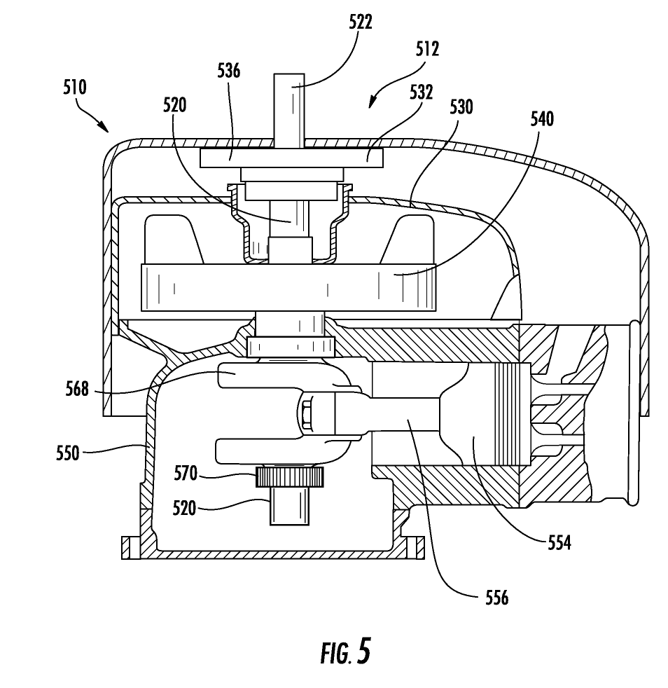

FIG. 5 shows a schematic cut-away side view of an engine according to an exemplary embodiment. The motor is in the form of an engine 510 having a vertical crankshaft 520. The crankshaft 520 has a power take-off extension 522 designed to transfer rotational torque outside of the engine 510. The power take-off extension 522 extends through a top 512 of the engine 510. The engine 510 also includes a housing 530 with a recoil starter 532 mounted to the housing 530. The recoil starter includes a handle (not shown), and a rewind 536 around which a pull cord is wound. A fuel tank and oil fill cap are attached to the housing 530. The housing 530 includes an aperture through which extends the power take-off extension 522.

The engine 510 further includes a flywheel 540 and a crankcase 550 surrounding a portion of the crankshaft 520. A piston 554 is coupled to the crankshaft 520 via a connecting rod 556. A combustion chamber is adjacent to the piston 554, where the combustion chamber is designed to direct an explosive force to move (i.e., linearly translate) the piston 554. Translational force of the piston 554 is converted to rotational torque of the crankshaft 520. The crankcase 550 is also designed to hold an oil reservoir for cooling and lubricating components within the crankcase 550, such as the piston 554.

The engine 510 has a four-stroke cycle, the four strokes including air and fuel intake into the combustion chamber, compression by the piston 554, combustion of the fuel, and exhaust of the spent fuel and air. During operation of the engine 510, the four strokes occur with every two rotations of the crankshaft 520.

Still referring to the embodiment of FIG. 5, the power take-off extension 522, located at an upper end of the crankshaft 520, is designed to engage a powered tool such that rotation of the crankshaft 520 may be transferred to the powered tool. The crankshaft 520 also includes a flywheel section, designed to support the flywheel 540. A pair of counterweights 568 balance the forces associated with reciprocation of the piston 554.

In at least one embodiment, the crankshaft 520 further includes a crank gear 570 designed to couple the shaft to gearing. The crankshaft 520 also includes the flywheel 540 integrally joined to the flywheel section. The flywheel 540 can be placed in other locations on the crankshaft 520. In some embodiments, the crankshaft 520 is monolithic, machined from a single piece.

As shown in FIG. 5, the recoil starter includes a housing, a pull cord, and a ratcheting member designed to engage the flywheel in a first rotation direction, and to disengage the crankshaft in a second rotation direction. In some embodiments, the recoil starter includes an opening in the center of the housing designed to allow a crankshaft to extend through the opening. However, in other embodiments, the ratcheting member and the crankshaft have different axes of rotation (i.e., not colinear), and torque is transferred from the recoil starter to the crankshaft or flywheel via a gear, a pulley, a belt, or a shaft. In still other embodiments, an automatic starter is used in place of a recoil starter.

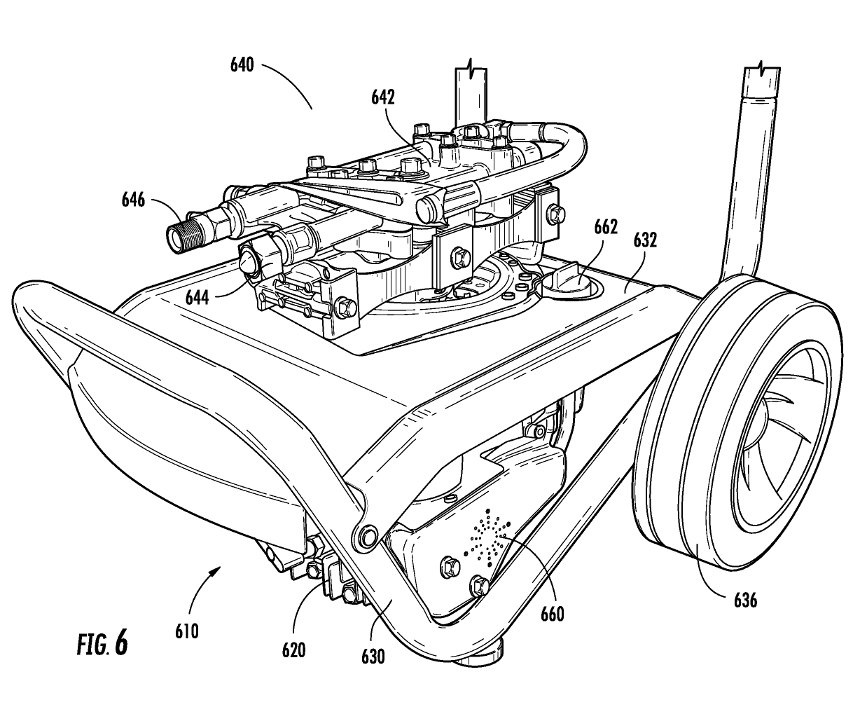

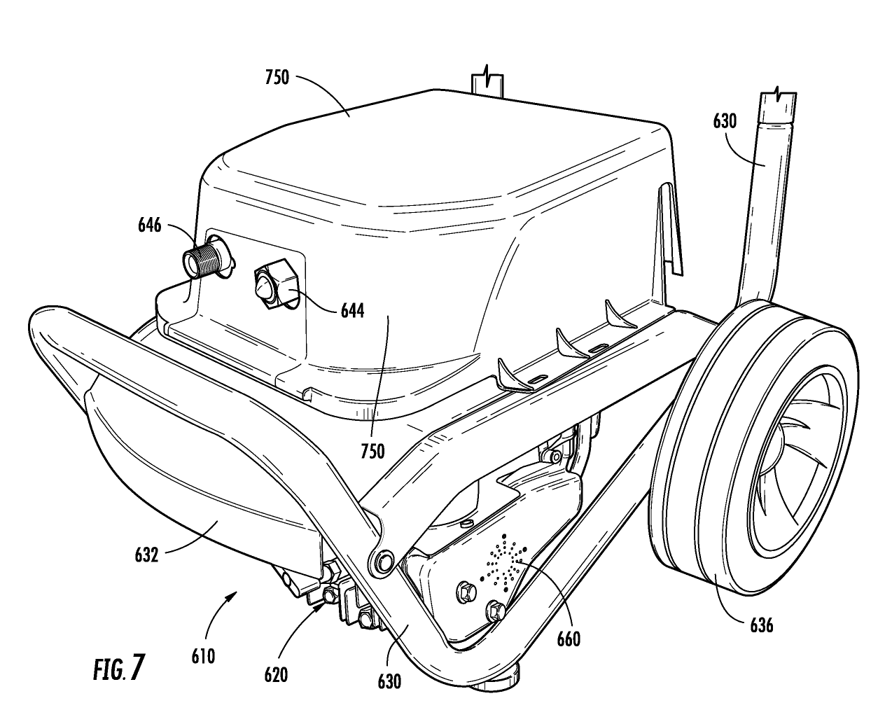

FIGS. 6-7 show a side perspective view of a pressure washer system 610 according to an exemplary embodiment. The pressure washer system 610 includes a pump 640 having a housing 642, an inlet 644, and an outlet 646. The pressure washer system 610 also includes an engine 620 having an exhaust muffler shell 660, a oil fill cap 662, and other such components characteristic of combustion engines, such as an integrated fuel tank and fuel cap. In addition, the pressure washer system 610 includes a support frame 630 having wheels 636 and a base plate 632, where the pressure washer system 610 can be rolled to a desired location for operation. The pump 640 is coupled to the engine 620 via the base plate 632 such that both the pump 640 and the engine 620 are mounted directly to the base plate 632. The base plate 632 includes an aperture allowing an upwardly-directed power take-off extension of the crankshaft of the engine 620 to engage the pump 640 through the base plate 632. In FIG. 7, the pump 640 is covered by a protective shroud 750.

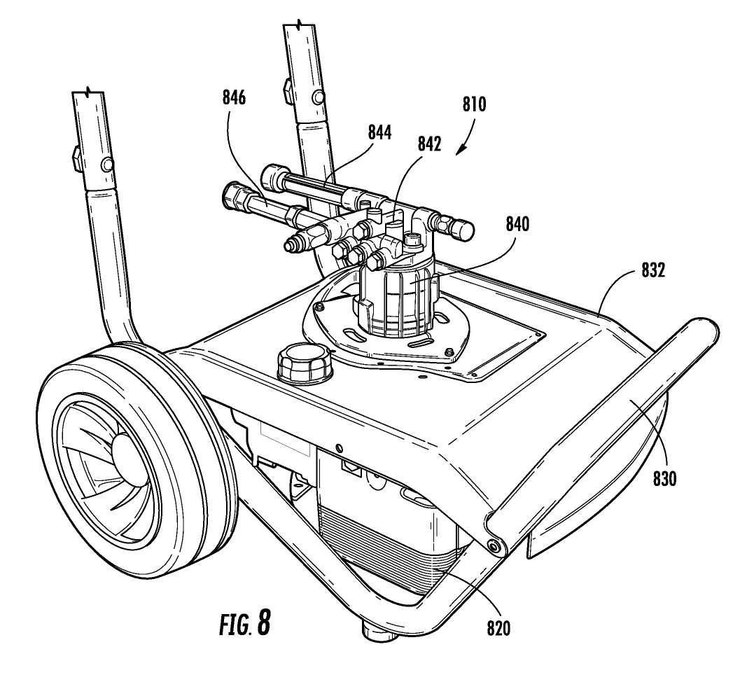

FIG. 8 shows a side perspective view of a pressure washer system 810 according to yet another exemplary embodiment. The pressure washer system 810 includes a pump 840 having a housing 842, an inlet 844, and an outlet 846. The pressure washer system 810 also includes an engine 820 and a support frame 830 having a base plate 832. The pump 840 is mounted to the engine 820, and the engine 820 is mounted directly to the base plate 832. As shown in FIG. 8, the engine 820 has been attached to the base plate 832 so that the engine 820 is substantially below the base plate and the pump 840 is substantially above the base plate 832. The base plate 832 includes an aperture allowing an upwardly-directed power take-off extension of the crankshaft of the engine 820 to engage the pump 840.

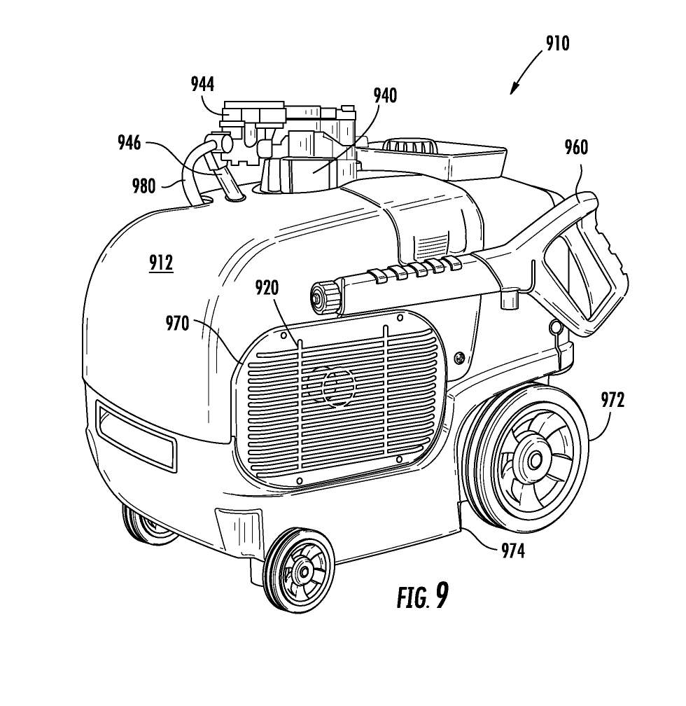

FIG. 9 show a side perspective view of a pressure washer system 910 according to still another exemplary embodiment. The pressure washer system 910 includes a housing 912 substantially surrounding a support frame (not shown), a motor 920 (shown through a side air vent 970), and a pump 940. A portion of the pump 940 extends from the top of the housing 912, the portion including an inlet 944 and an outlet 946 for attaching hoses. Also shown in FIG. 9, a chemical injection hose 980 is coupled to the pump 940 such that chemicals stored within a container inside the housing 912 are added to water flowing through the pump 940. Such chemicals could include soaps, pesticides, solvents, plant nutrients, and other chemicals. The pump 940 is coupled to a top of the motor 920, where an upwardly-directed power take-off extension of the motor 920 engages the pump 940.

In some embodiments, the pressure washer system 910 includes a drive shaft coupled to the motor 920 to power the wheels 972. The pressure washer system 910 may be remotely controlled and also includes a spray gun 960 or a spray canon that may be remotely aimed and activated via radio frequency control, a wired controller, or other forms of remote communication.

Some embodiments of powered tool systems within the scope of this disclosure are not pressure washer systems. For example, some embodiments may include a powered tool in the form of a top-mounted rotor for an electric generator system, such as an emergency home or business secondary generator. Other embodiments include a powered tool in the form of a top-mounted rotor for portable electric generator system, such as a small electric generator with a natural gas, liquid propane, or gasoline-powered engine coupled to a mounting platform with wheels. The rotor is coupled to the top of an engine with an upwardly-directed power take-off extension.

In at least one embodiment, the powered tool is in the form of a top-mounted centrifugal squirrel cage fan. The fan is designed to pull air into a fan inlet in the center of the centrifugal squirrel cage fan, accelerate the air, and then drive the air through a fan housing having a fan exhaust outlet. The centrifugal squirrel cage fan is coupled to the top of an engine with an upwardly-directed power take-off extension.

In another embodiment, the powered tool is the form of a top-mounted centrifugal water pump. The water pump is designed to receive water into a pump inlet in the center of the centrifugal water pump, accelerate the water, and then drive the water through a pump housing having a pump exhaust outlet. The centrifugal water pump is coupled to the top of an engine with an upwardly-directed power take-off extension.

In yet another embodiment, the powered tool is in the form of a top-mounted, wheeled leaf blower fan. The leaf blower fan is designed to drive air through a blower exhaust duct. The leaf blower fan is coupled to the top of an engine with an upwardly-directed power take-off extension.

In another embodiment, the powered tool is in the form of a top-mounted log-splitter hydraulic pump. The log-splitter hydraulic pump is used for driving a ram configured to push a log into a splitting wedge. The log-splitter hydraulic pump is coupled to an engine with an upwardly-directed power take-off extension.

In still another embodiment, the powered tool is in the form of top-mounted wood chipper/shredder cutting blades. The cutting blades are coupled to an engine with an upwardly-directed power take-off extension via a pulley.

According to other embodiments, the powered tool systems are in the form of other top-mounted tools that are mounted substantially vertically above a motor, and where the motor comprises an upwardly-directed power take-off extension for engaging a top-mounted tool. In some embodiments there is vertical overlap between the top-mounted tool and the motor, but the top-mounted tool is still substantially vertically above the motor because, for example, the center of mass of the top-mounted tool is above the center of mass of the motor when the system is at rest in a general right-side-up orientation, such as when the tool is at an at-rest position, as-stored position, or a position intended for operation of the system.

The construction and arrangements of the powered tool system and the engine as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer system, comprising:
a mounting platform;
a water pump having a housing with an inlet and an outlet formed therein,
a motor mounted to the mounting platform and coupled to the water pump such that the motor is configured to drive the water pump, and wherein the motor is mounted vertically below the water pump.

2. The system of claim 1, wherein the pump is mounted substantially on top of the motor.

3. The system of claim 2, wherein the motor is an internal combustion engine having an upwardly-directed power take-off extension for engaging the pump.

4. The system of claim 3, wherein the pump is an axial cam pump.

5. The system of claim 3, wherein the pump is a positive displacement pump.

6. The system of claim 5, wherein the mounting platform is wheeled, whereby the pressure washer system can be rolled.

7. The system of claim 6, wherein the engine further comprises a lubrication system and a fuel system, wherein the lubrication system and the fuel system rely upon the engine being in a non-inverted orientation.

8. The system of claim 7, wherein the wheeled platform comprises a frame having at least two wheels, a base plate, and a handle, wherein the frame is configured to be rocked about the at least two wheels and rolled by a user to a desired location for operation.

9. The system of claim 8, wherein the pump is mounted to the engine via the base plate such that the pump and the engine are fastened to the base plate, and the power take-off extension is engaged by the pump through an opening in the base plate.

10. The system of claim 8, wherein the engine further comprises a housing with an opening formed therein, wherein the power take-off extension is engaged by the pump through the opening in the housing.

11. A powered tool system, comprising:
a support frame;
a powered tool; and
an internal combustion engine mounted to the support frame and coupled to the powered tool such that the engine is configured to drive the powered tool, wherein the powered tool is mounted substantially above the engine, and wherein the engine comprises an upwardly-directed power take-off extension for engaging the powered tool.

12. The system of claim 11, wherein the powered tool comprises a water pump for a pressure washer system.

13. The system of claim 11, wherein the powered tool comprises a rotor for an electric generator.

14. The system of claim 11, wherein the powered tool comprises at least one of (a) a centrifugal squirrel cage fan; (b) a centrifugal water pump; (c) a wheeled leaf blower fan; (d) a log-splitter hydraulic pump; and (e) cutting blades for a wood chipper.

15. A combustion engine, comprising:
a crankshaft;
a power take-off extension;
a crankcase enclosing the crankshaft, wherein the power take-off extension is coupled to the crankshaft extending through an opening in the crankcase; and
a lubrication system for distributing lubricant within the crankcase, wherein the lubrication system relies upon the engine generally being in a first orientation, wherein the engine in the first orientation has a top and a bottom, with the top vertically above the bottom, and
wherein the power take-off extension extends vertically upward through the top of the engine.

16. The engine of claim 15, further comprising a fuel system including a fuel tank, wherein the fuel system relies upon the engine generally being in the first orientation.

17. The engine of claim 16, wherein the lubrication system and the fuel system do not function properly if the engine is inverted from the first orientation.

18. The engine of claim 17, further comprising a housing attached to the crankcase, the housing having an aperture formed therein, wherein the power take-off extension extends through the aperture.

19. The engine of claim 18, wherein the housing includes a tool mounting surface with a plurality of fastening holes formed therein, whereby a tool can be mounted to the housing and coupled to the power take-off extension.

20. The engine of claim 19, further comprising a recoil starter, wherein the recoil starter is either (a) a side-mounted recoil starter not aligned with the power take-off extension or (b) a recoil starter with a central opening aligned with the power take-off extension, the central opening configured to allow the power take-off extension to pass therethrough.
